(19) United States
(12) Patent Application Publication
(10) Pub. No.: US 2025/0171667 A1
(43) Pub. Date: May 29, 2025

(54) Solvent-free Polyurethane Adhesive Composition and Use Thereof

(71) Applicant: Henkel AG & Co. KGaA, Düsseldorf (DE)

(72) Inventors: JiangWei Wang, Shanghai (CN); JingJing Liang, Shanghai (CN); YanLi Huo, Shanghai (CN); Kerstin van Wijk, Düsseldorf (DE)

(21) Appl. No.: 19/033,793

(22) Filed: Jan. 22, 2025

Related U.S. Application Data
(63) Continuation of application No. PCT/CN2022/107350, filed on Jul. 22, 2022.

(51) Int. Cl. C09J 175/08

(52) U.S. Cl. CPC C09J 175/08

(57) ABSTRACT

The present invention relates to a solvent-free polyurethane adhesive composition and the use thereof. In particular, the present invention provides a solvent-free polyurethane adhesive composition comprising: (A) at least one isocyanate group-containing component comprising at least one isocyanate-terminated polyurethane prepolymer obtained by reacting a polyol mixture comprising: (a) at least one polyester polyol obtained by reacting a reactant mixture comprising: (i) at least one polycarboxylic acids selected from at least one aliphatic dicarboxylic acid and at least one aromatic dicarboxylic acid, (ii) neopentyl glycol, and (iii) at least one polyol having a weight average molecular weight of from 50 to 300 g/mol other than neopentyl glycol, and (b) at least one polyether polyol having a weight average molecular weight of from 200 to 4000 g/mol, with a stoichiometric excess of at least one polyisocyanate, and (B) at least one hydroxyl group-containing component; wherein the isocyanate-containing component (A) has an NCO content of from more than 10% to less than 14% by weight.

### TECHNICAL FIELD

The present invention relates to a solvent-free polyurethane adhesive composition and the use thereof. In particular, the present invention relates to a solvent-free polyurethane adhesive composition for laminating PET and aluminum foil in food packaging.

### BACKGROUND

Film-to-film and film-to-foil laminates are used in the packaging of various food products and other industrial products. Adhesives and coatings are used in making these composite structures, since it is often difficult to achieve satisfactory bonding of films of differing composition using co-extrusion or heat-welding techniques. Laminates of this type are required to have a number of key performance features such that the packaged goods can be safely placed, transported and stored until they are used by the customer. During the many stages of packaging, the laminates are subjected to various processes like printing, pouching, bag making, filling, boxing, transporting etc. For more than 20 years, formulations based on polyurethanes produced principally by the reaction of polyols and polyisocyanates were used. These products were mainly solvent solutions of polyester and or polyether polyols reacted suitably with aromatic isocyanates like MDI (diphenylmethane diisocyanate), TDI (toluene diisocyanate) and the many reaction products of diisocyanates. Due to increased environmental awareness, such solvent solutions were replaced with solvent-free polyurethanes in most applications. While a few water-based laminating adhesives are known, most are provided as 100% solids systems. These systems were essentially similar to solvent-carried products but they contained significant amounts of free monomeric isocyanates. Their volatility, the health effects of such isocyanates and their reaction products with atmospheric moisture resulting in the formation of aromatic diamines have been cause for concern, especially in food packaging. Almost all adhesives and most of the coatings used in the industry are based on polyurethanes. When films that are considered high barrier, meaning they do not allow the passage of gases freely through them, are to be laminated, such free isocyanate-containing adhesives cause an appearance problem. Trace amounts of moisture present in the film surfaces react with isocyanates in a well-known reaction producing carbamic acid. This unstable acid releases carbon dioxide gas. Due to the impervious nature of the films, the carbon dioxide is trapped as bubbles causing an appearance problem.

US 2019/0127616 A1 disclosed a solventless adhesive comprising an isocyanate component comprising at least one isocyanate prepolymer that is the reaction product of reactants comprising at least one isocyanate, at least one polyol, and a branched alkane diol, and a polyol component comprising at least one polyol and a branched alkane diol. The branched alkane diol can comprise a single side alkyl chain, such as 3-methyl-1,5-pentanediol, 2-methyl-1,3-propanediol, and combinations thereof. After immersing in the water throughout the boiling in bag, the pouch formed by the laminated film showed good appearance without tunneling.

EP3947588 A1 disclosed a solventless adhesive composition comprising (A) an isocyanate prepolymer having a side chains represented by —R₂—(O—R₁—O)ₙ—R₃ and (B) an isocyanate-reactive component, and exhibiting improved bond strength, heat seal strength, adhesive COF property and optical appearance on PET ink/MPET lamination.

None of the above prior art discloses a solvent-free adhesive composition exhibiting desirably low viscosity and satisfactory optical appearance, especially on PET and aluminum foil. Therefore, there is a need in the art for a solvent-free polyurethane adhesive composition that has desirably low viscosity and exhibits satisfactory optical appearance when laminated on films or foils, especially on PET/aluminum foil.

### SUMMARY OF THE INVENTION

Disclosed herein is a solvent-free polyurethane adhesive composition comprising:
(A) at least one isocyanate group-containing component comprising at least one isocyanate-terminated polyurethane prepolymer obtained by reacting a polyol mixture comprising:
   (a) at least one polyester polyol obtained by reacting a reactant mixture comprising:
      (i) at least one polycarboxylic acids selectee from at least one aliphatic dicarboxylic acid and at least one aromatic dicarboxylic acid,
      (ii) neopentyl glycol, and
      (iii) at least one polyol having a weight average molecular weight of from 50 to 300 g/mol other than neopentyl glycol, and
   (b) at least one polyether polyol having a weight average molecular weight of from 200 to 4000 g/mol,
   with a stoichiometric excess of at least one polyisocyanate, and
(B) at least one hydroxyl group-containing component;
wherein the isocyanate-containing component (A) has an NCO content of from more than 10% to less than 14% by weight.

Also disclosed herein is a laminate, comprising a first layer, a second layer, and an adhesive layer sandwiched therebetween, wherein the first and second layer are independently of each other selected from films made of PET (Polyethylene Glycol Terephthalate), PP (Polypropylene), OPP (Oriented Polypropylene), CPP (Casted Polypropylene), BOPP (Biaxially oriented Polypropylene), PE (Polyethylene), aluminum foil, PA (Polyamide), VMPET (Vacuum Metallized Polyethylene Glycol Terephthalate) and VMCPP (Vacuum Metallized Casted Polypropylene), preferably PET (Polyethylene Glycol Terephthalate) and aluminum foil, and the adhesive layer being formed by curing the adhesive composition according to the present invention.

Yet disclosed herein is a food pouch formed by the laminate of the present invention.

Yet disclosed herein is the use of the solvent-free polyurethane adhesive composition according to the present invention or laminate according to the present invention in manufacturing food packaging.

Other features and aspects of the subject matter are set forth in greater detail below.

### BRIEF DESCRIPTION OF THE FIGURES

FIG. 1 shows the photo of the optical appearance of the solvent-free polyurethane adhesive composition according to Example 1 after being laminated to PET film and aluminum foil.

FIG. 2 shows the photo of the optical appearance of the solvent-free polyurethane adhesive composition according to Comparative Example 1 after being laminated to PET film and aluminum foil.

FIG. 3 shows the photo of the optical appearance of the solvent-free polyurethane adhesive composition according to Example 3 after being laminated to PET film and aluminum foil.

### DETAILED DESCRIPTION

It is to be understood by one of ordinary skill in the art that the present discussion is a description of exemplary embodiments only and is not intended as limiting the broader aspects of the present invention.

Unless specified otherwise, in the context of the present invention, the terms used are to be construed in accordance with the following definitions.

Unless specified otherwise, as used herein, the terms “a”, “an” and “the” include both singular and plural referents.

The term “composition”, as used herein, refers to a mixture of materials which comprises the composition, as well as reaction products and decomposition products formed from the materials of the composition.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “room temperature” as used herein refers to a temperature of about 20° C. to about 25° C., preferably about 25° C.

The term “polyol” used herein should be understood as a molecule carrying two or more hydroxyl groups, irrespective of whether the molecule contain other functional groups. However, a polyol useful in the present invention preferably contains only OH groups, or if other functional groups are present, none of these other functional groups is reactive at least to isocyanates under the condition of the present invention.

Unless specified otherwise, the recitation of numerical end points includes all numbers and fractions subsumed within the respective ranges, as well as the recited end points.

The molecular weights refer to weight average molecular weights (Mw), unless otherwise stipulated. All molecular weight data refer to values obtained by gel permeation chromatography (GPC), unless otherwise stipulated, e.g., according to DIN 55672.

Unless otherwise defined, all terms used in the present invention, including technical and scientific terms, have the meaning as commonly understood by one of the ordinary skilled in the art to which this invention belongs.

According to the first aspect of the present invention, disclosed herein is a solvent-free polyurethane adhesive composition comprising:
(A) at least one isocyanate group-containing component comprising at least one isocyanate-terminated polyurethane prepolymer obtained by reacting a polyol mixture comprising:
   (a) at least one polyester polyol obtained by reacting a reactant mixture comprising:
      (i) at least one polycarboxylic acids selected from at least one aliphatic dicarboxylic acid and at least one aromatic dicarboxylic acid,
      (ii) neopentyl glycol, and
      (iii) at least one polyol having a weight average molecular weight of from 50 to 300 g/mol other than neopentyl glycol, and
   (b) at least one polyether polyol having a weight average molecular weight of from 200 to 4000 g/mol,
   with a stoichiometric excess of at least one polyisocyanate, and
(B) at least one hydroxyl group-containing component;
wherein the isocyanate-containing component (A) has an NCO content of from more than 10% to less than 14% by weight.

### (A) Isocyanate Group-Containing Component

According to the present invention, the at least one isocyanate group (NCO)-containing component (A) comprises at least one isocyanate group (NCO)-terminated polyurethane prepolymer obtained by reacting a polyol mixture comprising (a) at least one polyester polyol obtained by reacting a reactant mixture comprising: (i) at least one polycarboxylic acids selected from at least one aliphatic dicarboxylic acid and at least one aromatic dicarboxylic acid, (ii) neopentyl glycol, and (iii) at least one polyol having a weight average molecular weight of from 50 to 300 g/mol other than neopentyl glycol, and (b) at least one polyether polyol having a weight average molecular weight of from 200 to 4000 g/mol, with a stoichiometric excess of at least one polyisocyanate.

Preferably, the NCO-terminated polyurethane prepolymer useful in the present invention has a weight average molecular weight (Mw) of from 200 to 100,000 g/mol, more preferably in the range from 500 to 5,000 g/mol.

Preferably, the at least one NCO-terminated polyurethane prepolymer constitutes from 5 to 95%, preferably from 30 to 60% by weight of total weight of the adhesive composition.

### (A) Polyester Polyol

According to the present invention, suitable polyester polyol in the present invention can be obtained by reacting a reactant mixture comprising: (i) at least one polycarboxylic acids selected from at least one aliphatic dicarboxylic acid and at least one aromatic dicarboxylic acid, (ii) neopentyl glycol, and (iii) at least one polyol having a weight average molecular weight of from 50 to 300 g/mol other than neopentyl glycol. By selected neopentyl glycol to prepare the polyester polyol, it can produce polyurethane adhesive composition having good optical appearance when laminated and cured.

In one preferred embodiment, the reactant mixture comprises at least one aliphatic dicarboxylic acid and at least one aromatic dicarboxylic acid.

Specific examples of suitable aliphatic dicarboxylic acid as component (i) can be C2-C36 aliphatic dicarboxylic acid selected from malonic acid, succinic acid, glutaric acid, adipic acid, pimelic acid, suberic acid, azelaic acid, sebacic acid, 1,12-dodecanedioic acid, dimer acid and combinations thereof, preferably from adipic acid, sebacic acid, succinic acid, their corresponding polycarboxylic anhydrides, and combinations thereof.

Specific examples of suitable aromatic dicarboxylic acid as component (i) can be C8-20 aromatic dicarboxylic acid selected from isophthalic acid, terephthalic acid, diphenic acid and 2,6-naphthalenedicarboxylic acid, and their corresponding polycarboxylic anhydrides, and combinations thereof, preferably selected from isophthalic acid, terephthalic acid, their corresponding polycarboxylic anhydrides, and combinations thereof.

Specific examples of suitable polyol having a weight average molecular weight of from 50 to 300 g/mol other than neopentyl glycol as component (iii) can be selected from ethylene glycol, diethylene glycol, 1,2-butanediol, 1,4-butanediol, 1,6-hexanediol, 2-methyl-1,3-propanediol, glycerol, trimethylolpropane, 1,2-propyleneglycol, dipropylene glycol, triethylene glycol, 1,4-cyclohexanedimethanol, 2-butyl-2-ethylpropanediol, pentaerythritol, polytetramethylene ether glycol and combinations thereof, preferably selected from ethylene glycol, diethylene glycol, 1,2-butanediol, 1,4-butanediol, 2-methyl-1,3-propanediol, and combinations thereof.

It is possible to use the polyester polyols prepared by polycondensation of the neopentyl glycol (ii) and at least one polyol having a weight average molecular weight of from 50 to 300 g/mol other than neopentyl glycol (iii) of the present invention with a stoichiometric excess of the at least one polycarboxylic acids selectee from at least one aliphatic dicarboxylic acid and at least one aromatic dicarboxylic acid (i) of the present invention. The aforementioned polycarboxylic acids can be used individually or as mixtures of two or more thereof.

A method of preparing the suitable polyester polyols useful in the present invention comprises the following steps: (i) polycarboxylic acid(s), neopentyl glycol and other polyol(s) described above are mixed under the temperature of from 120˜250° C. with the protection of nitrogen flow for 6 to 12 hours to ensure polycondensation occurs; (ii) to apply a vacuum of 50-900 mBar in the second half of the reaction for 1 to 12 hours to improve the molecular weight of the obtained polyester polyol.

Preferably, the polyester polyol useful in the present invention has a weight average molecular weight (Mw) 450 to 2,000 g/mol, more preferably in the range from 800 to 1500 g/mol.

In some embodiments, useful polyester polyols can be modified by vegetable oil selected from castor oil, soybean oil, palm oil, coconut oil and combinations thereof. When used vegetable oil modified polyester polyols, the vegetable oil is preferably in an amount of no more than 5% by weight of the adhesive composition. Preferable adhesive composition of the present invention is not comprised of any vegetable oil.

It is also possible to use commercially available products in the present invention. Examples thereof include PES 5622, PES 9000 from Henkel, CP-2070 from Nanjing CSD, and ES-980 from SKC.

With particular preference, the polyester polyols used to prepare component (A) may be present in an amount of from 5% to 30% by weight, and more preferably from 10% to 25% by weight, based on the weight of the component (A).

### Polyether Polyol

According to the present invention, at least one polyether polyol having a weight average molecular weight of from 200 to 4000 g/mol is comprised to prepared for the component (A) used in the present composition.

The polyether polyols used for preparing component (A) in the present invention are well known to those skilled in the art. These polyether polyols are obtained by copolymerizing at least one compound of ethylene oxide, propylene oxide, butylene oxide, tetrahydrofuran, etc. with at least one compound having at least two active hydrogen atoms on average in one molecule such as the polyhydric alcohols list above which include ethylene glycol, propylene glycol, dipropylene glycol, glycerol, and combinations thereof. Other suitable polyhydric compounds include sucrose, ethylenediamine, propylenediamine, triethanolamine, 1,2-propanedithiol, and combinations thereof.

Preferred polyether polyols used for preparing component (A) can be selected from polytetramethylene ether glycol, poly(oxypropylene) glycol, polyethylene oxide, polybuthylene oxide, and ethylene oxide endcapped versions of any of the foregoing, as well as the combinations thereof. The most preferred polyether polyols are polytetramethylene ether glycol, poly(oxypropylene) glycol, ethylene oxide endcapped poly(oxypropylene)glycol, and combinations thereof.

In preferred embodiments, the polyether polyol has an average molecular weight (Mw) of from 450 to 2,000 g/mol.

It is possible to use commercially available products in the present invention. Examples thereof include DP 450, DP 1000M and DP 2000M from Kukdo Chemical Company.

With particular preference, the polyether polyol may be present in an amount of from 10% to 50% by weight, and more preferably from 20% to 40% by weight, based on the weight of the component (A).

### Polyisocyanate

According to the present invention, the component (A) of the present invention comprises at least one NCO-terminated polyurethane prepolymer obtained by reacting a polyol mixture described above with a stoichiometric excess of at least one polyisocyanate.

As used herein, the term “polyisocyanate” is understood to have preferably from 2 to 4 isocyanate groups per molecule. Preferably, the polyisocyanate is diisocyanate, including aliphatic, alicyclic, aromatic diisocyanates.

In one embodiment, the aromatic diisocyanate can be selected from 2,2′-methylene diphenyl diisocyanate (MDI), 4,4′-methylene diphenyl diisocyanate, 2,4′-methylene diphenyl diisocyanate, 2,4-toluene diisocyanate (TDI), 2,6-toluene diisocyanate, 1,3-phenylenediisocyanate (PDI), 1,4-phenylenediisocyanate, 1,4-naphthylene diisocyanate (NDI), 1,5-naphthylene diisocyanate, tetramethyl xylylene diisocyanate (TMXDI), 4,4′-dibenzyl diisocyanate, xylylene diisocyanate (XDI), and combinations thereof.

In one embodiment, the aliphatic isocyanate can be selected from butane-1,4-diisocyanate, 1,6-hexamethylene diisocyanate (HMDI), 1,6-diisocyanato-2,2,4-trimethylhexane, 1,12-diisocyanato-dodecane, and combinations thereof.

In one embodiment, the alicyclic isocyanate can be selected from isophorone diisocyanate (IPDI), 4,4-dicyclohexylmethanediisocyanate, 1,3-cyclohexane diisocyanate, 1,4-cyclohaxene diisocyanate, 1-methyl-2,4-diisocyanato-cyclohexane, and combinations thereof.

Preferably, the polyisocyanate can be selected from 2,2′-methylene diphenyl diisocyanate, 4,4′-methylene diphenyl diisocyanate, 2,4′-methylene diphenyl diisocyanate, 2,4-toluene diisocyanate, 1,6-hexamethylene diisocyanate, and combinations thereof. More preferably, MDI is used as the polyisocyanate.

It is possible to use commercially available products in the present invention. Examples thereof include Desmodur 44 C FUSED, Desmodur 0118 I and Desmodur 44M from Covestro, Vannate MDI 100F from Wanhua Chemicals and Supresec 1809 from HUNTSMAN.

With particular preference, the polyisocyanate may be present in an amount of from 40% to 85% by weight, and more preferably from 55% to 80% by weight, based on the weight of the component (A).

The stoichiometric excess of polyisocyanate to polyol mixture described above is—in relation to the molar ratio of —NCO groups to —OH groups—in particular, from more than 1:1 to 50:1, preferably 2:1 to 10:1 in the NCO-containing component (A). Due to the excess isocyanate used, the NCO-terminated polyurethane prepolymer usually have certain amounts of isocyanate monomers. To achieve the desired effect of the present invention, the NCO-containing component (A) has an NCO content of from more than 10% to less than 14% by weight. If the NCO content is out of the claimed range, the optical appearance of the lamination formed by the adhesive composition would show orange peel, small dots or bubbles.

The NCO content based on the isocyanate-containing component (A) can be determined according to ISO 14896/3 using acetone as solvent.

### (A) Hydroxyl Group-Containing Component

According to the present invention, the component (B) of the solvent-free polyurethane adhesive composition can be at least one hydroxyl group (OH)-containing component.

Preferably, the OH-containing component (B) in the present invention has a hydroxyl value in the range of from 10 to 1500 mgKOH/g, preferably 56 to 560 mgKOH/g.

The term “the hydroxyl value” used herein is defined as the number of milligrams of potassium hydroxide required to neutralize the acetic acid taken up on acetylation of one gram of the hydroxyl component, expressed in units of the mass of potassium hydroxide (KOH) in milligrams equivalent to the hydroxyl content of one gram of the hydroxyl component. In the present invention, the hydroxyl value is determined according to DIN 53240-2.

Preferably, the OH-containing component (B) in the present invention has an average hydroxyl group functionally of from 2 to 5, preferably from 2 to 4.

The viscosity of the OH-containing component (B) is not particularly limited. From the perspective of end use, the viscosity of the component (B) preferably in the range of from 50 to 20000 mPa·s at 25° C., more preferably in the range of from 500 to 10000 mPa·s at 25° C.

Generally, the OH-containing component (B) may be any and all polyols commonly used, e.g., polyester polyols, polyether polyols, polyester ether polyols, polycarbonate polyols, and combinations thereof. In some embodiments, the polyols useful to prepare the component (B) include polyol mixture used in the preparation of the NCO-terminated polyurethane prepolymer in the component (A).

With particular preference, the OH-containing component (B) may be present in an amount of from 5 to 95% by weight, and more preferably from 10 to 56% by weight, based on the total weight of the adhesive composition.

### Additive

Optionally, the conventional additives may be, independently of each other, comprised in one of or both components (A) and (B), without impairing the objective of the present invention. Such additive can be those commonly used in the art, such as filler, colorants, anti-defoamer agent, etc.

Examples of filler selected from calcium carbonate, titanium dioxide, carbon black, talc powder, porcelain clay, mica powder, diatomite, alumina, and combinations thereof.

Examples of colorants include pigments which may be selected from metal oxide pigments, titanium dioxide, optionally surface-treated, zirconium oxide or cerium oxide, zinc oxide, iron oxide (black, yellow or red), chromium oxide, manganese, and combinations thereof.

With particular preference, the additive(s) may be present in an amount of from 0 to 5% by weight, and preferably from 0.01% to 5% by weight, based on the total weight of the adhesive composition.

### Mixing Ratio of the Component (A) and (B)

In some embodiments, the mixing ratio of the NCO-containing component (A) and the OH-containing component (B) is from 5:100 to 19:1 parts by weight, preferably from 50:100 to 200:100 parts by weight.

### Adhesive Composition

In particular preferred embodiments, the solvent-free polyurethane adhesive composition, based on the total weight of the adhesive composition, comprises:
(A) from 5 to 95%, preferably from 30 to 60% by weight of at least one NCO-terminated polyurethane prepolymer obtained by reacting a polyol mixture comprising
   (a) at least one polyester polyol obtained by reacting a reactant mixture comprising:
      (i) at least one polycarboxylic acids selected from at least one aliphatic dicarboxylic acid and at least one aromatic dicarboxylic acid,
      (ii) neopentyl glycol, and
      (iii) at least one polyol having a weight average molecular weight of from 50 to 300 g/mol other than neopentyl glycol, and
   (b) at least one polyether polyol having a weight average molecular weight of from 200 to 4000 g/mol, with a stoichiometric excess of at least one polyisocyanate, and
(B) from 5 to 95%, preferably (B) from 10 to 56% by weight of at least one OH-containing component;
wherein the NCO-containing component (A) has an NCO content of from more than 10% to less than 14% by weight.

In particular preferred embodiments, the at least one NCO-containing component (A) comprises at least one NCO-terminated polyurethane prepolymer obtained by reacting a polyol mixture comprising:
(a) from 5% to 30% by weight, and more preferably from 10% to 25% by weight of at least one polyester polyol, obtained by reacting a reactant mixture comprising: (i) at least one polycarboxylic acids selected from at least one aliphatic dicarboxylic acid and at least one aromatic dicarboxylic acid, (ii) neopentyl glycol, and (iii) at least one polyol having a weight average molecular weight of from 50 to 300 g/mol other than neopentyl glycol, and
(b) from 10% to 50% by weight, and more preferably from 20% to 40% by weight of at least one polyether polyol having a weight average molecular weight of from 200 to 4000 g/mol,
   with from 40% to 85% by weight, and more preferably from 55% to 80% by weight of at least one polyisocyanate, all above based on the weight of the component (A); wherein the NCO-containing component (A) has an NCO content of from more than 10% to less than 14% by weight.

In some embodiments, the NCO-containing component (A) of the present invention can be prepared by the following steps:
(i) adding polyisocyanate(s) into the reactor under 60° C. with protection of nitrogen flow;
(ii) the polyol mixture is introduced into the reactor and water content is controlled less than 300 ppm in the reactor, and then gradually increases temperature up to 80° C. and maintains for 2 to 3 hours; and
(iii) when NCO content reaches the required content of the present invention, the produced NCO-containing component (A) can be charged into a container under 60° C. with protection of nitrogen flow.

In some embodiments, the OH-containing component (B) can be obtained directly from commercial products as described herein. In other embodiments, the OH-containing component (B) can be obtained by mixing the useful polyols described herein by conventional methods.

The component (A) and the component (B) of the present invention can be mixed prior to use, and then the uncured adhesive composition can be applied to at least one of the flexible substrates to be bonded such as films, foils, and then the flexible substrates are laminated together and to cure afterwards.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the solvent-free polyurethane adhesive composition is not particularly limited, as long as a composition in which the above-described components are uniformly mixed.

### Laminate, Food Pouch and Use

In some embodiments, the solvent-free polyurethane adhesive composition of the present invention can cure from 25° C. to 65° C., preferably at room temperature for from 1 to 7 days.

As will be understood, the time and temperature curing profile for each solvent-free polyurethane adhesive composition will vary, and different compositions can be designed to provide the curing profile that will be suited to the particularly industrial manufacturing process.

In another aspect of the invention, provided herein is a laminate, comprising a first layer, a second layer, and an adhesive layer sandwiched therebetween, wherein the first and second layer are independently of each other selected from films made of PET (Polyethylene Glycol Terephthalate), PP (Polypropylene), OPP (Oriented Polypropylene), CPP (Casted Polypropylene), BOPP (Biaxially oriented Polypropylene), PE (Polyethylene), aluminum foil, PA (Polyamide), VMPET (Vacuum Metallized Polyethylene Glycol Terephthalate) and VMCPP (Vacuum Metallized Casted Polypropylene), preferably PET and aluminum foil, and the adhesive layer being formed by curing the adhesive composition according to the present invention.

A “layer” is any substrate or film that is 0.5 mm or less in one dimension and is 1 cm or more in both of the other two dimensions and have a property of flexibility (e.g., flexible layers i.e., the layers can be bent using no greater than the force of two hands).

The first layer and/or second layer can be of a single material and a single layer or can include multiple layers of the same or different material described herein.

In particularly preferred embodiments, the solvent-free polyurethane adhesive composition of the present invention is used for laminating PET (Polyethylene Glycol Terephthalate) and aluminum foil.

Generally, the laminate can have a size of from 10 to 20,000 meters, from 10 to 15,000 meters and preferably from 20 to 8,000 meters in length and with a thickness of from 0.1 μm to 0.5 mm, preferably from 1 μm to 10 μm. The quantities of the adhesive composition typically are around 1 to 5 g.

A method of forming a laminate using the solvent-free polyurethane adhesive composition of the present invention is disclosed herein. In some embodiments, the solvent-free polyurethane adhesive composition is firstly warmed up to temperature of less than 45° C., and then applied to a surface of the first layer. And then a surface of the second layer is brought into contact with the layer of the adhesive composition to form an uncured laminate. The adhesive composition may be applied by conventional solvent-free machine, e.g. Super Combi 3000 from Nordmeccanic. The adhesive composition may be then cured or allowed to cure. The uncured laminate may be subjected to pressure, for example by passing through nip rollers, which may or may not be heated. The uncured laminate may be heated to speed the cure reaction.

The process of the present disclosure may be carried out continuously or batchwise. An example of the continuous process is a roll to roll process. The layers are generally from 10 to 20,000 meters, from 10 to 15,000 meters and preferably from 20 to 8,000 meters in length and are typically transmitted at a speed in the range from 0.1 to 60 m/min, preferably from 3 to 45m/min, more preferable from 5 to 15 m/min.

The solvent-free polyurethane adhesive composition of the present invention can be applied to a layer using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The solvent-free polyurethane adhesive composition can be applied as a continuous or discontinuous coating, in a single or multiple layers and combinations thereof.

The laminates disclosed herein can be cut or otherwise shaped so as to have a shape suitable for any desired purpose, such as packaging material.

In yet another aspect of the invention, provided herein is a food pouch formed from the laminate of the present invention.

Examples of food that can be included in such packages include meats, cheeses, cereal, nuts, juices, sauces, and others.

The solvent-free polyurethane adhesive compositions and the laminate described above are useful in manufacturing food packages. Such food packages can be formed using techniques known to those of skills in the art based on the teachings herein and based on the particular use for the package (e.g. type of food, amount of food, etc.)

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials

DP 450 is polyether polyol having a Mw of 450 g/mol available from Kukdo Chemistry.

DP 2000 M is polyether polyol having a Mw of 2000 g/mol available from Kukdo Chemistry.

Castor oil is available from Ihsedu Agrochem.

XCP-355 is polyester polyol derived from ethylene glycol, 1,4-butanediol and adipic acid, available from Xuchuan Chemical (Suzhou) Co., Ltd.

PES 5622 is polyester polyol derived from diethylene glycol, neopentyl glycol, 1,2-butanediol, 2-methyl-1,3-propanediol, sebacic acid, terephthalic acid and succinic acid, available from Henkel.

PES 9000 is polyester polyol derived from monomers selected from ethylene glycol, neopentyl glycol, 1,4-butanediol, isophthalic acid and adipic acid, succinic acid, available from Henkel.

Desmodur 44M is polyisocyanate available from Covestro.

LOCTITE® LIOFOL LA 6011 is a polyol mixture of polyester polyols and polyether polyols, available from Henkel.

### Sample Preparation

NCO-containing component (A) of the Examples and Comparative Examples were synthesized by the following steps using the raw materials listed in Tables 1 and 2:
(i) polyisocyanate was added into the reactor under 60° C. with protection of nitrogen flow;
(ii) the polyols were introduced into the reactor and water content was controlled less than 300 ppm in the reactor, and then gradually increased temperature up to 80° C. and maintained for 2 to 3 hours; and
(iii) when NCO content reached the required content, the produced NCO-containing component (A) was charged into a container under 60° C. with protection of nitrogen flow.

The NCO-containing component (A) prepared in Examples and Comparative Examples were mixed with OH-containing component (B) listed in Tables 1 or 2 to form the adhesive composition.

### Testing Method:

### Viscosity

The viscosity in the present invention was measured at a temperature range at 50° C. with a 27 #spindle, and a Brookfield viscometer. The viscosity less than 10000 cps is acceptable.

### Optical Appearance

Laminated samples were prepared with these adhesive compositions in a Lamination machine (Super Combi 3000 available from Nordmeccanic). The adhesive composition of Examples and Comparative Examples was warmed to temperature of less than 45° C. and coated on PET/aluminum foils (available from Guoao Foil Company, Shanghai, China) in a size of 1000 m*0.7 m. The coating weight was set to form a laminated sample with a thickness of 1.6 to 1.7 μm.

The laminated sample was cured at 45° C. for 48 hours. The optical appearance of the laminated sample was visually observed and determined based on the following scale:

| Scale | Description |
|---|---|
| A | No bubble, shrinkage, small dots or orange peel observed |
| B | A few small dots or bubbles without any orange peel or |
| | shrinkage can be visually observed |
| C | Apparent orange peel, shrinkage, many bubbles or quite |
| | a few of small dots can be visually observed |

A is preferred and B can be acceptable.

### Inventive Example 1 and Comparative Examples 1 to 3

In this set of examples, one solvent-free polyurethane adhesive composition of the present invention (Ex.1) and three compositions having different NCO content out of the claimed range of the present invention (Com. Ex.1 to Com. Ex.3) were prepared based on parts by weight specified in the Table 1.

TABLE 1

| Components | Com. | Com. | | Com. |
|---|---|---|---|---|
| (weight/g) | Ex. 1 | Ex. 2 | Ex. 1 | Ex. 3 |
| Component (A) | | | | |
| DP 450 | 8.4 | 9.3 | 10.5 | 11.2 |
| DP 2000M | 21.0 | 23.4 | 26.3 | 28.1 |
| PES 5622 | 12.6 | 14.0 | 15.8 | 16.9 |
| Desmodur 44M | 58.1 | 53.3 | 47.3 | 43.8 |
| NCO % in | 16% | 14% | 11.5% | 10% |
| component (A) | | | | |
| Component (B) | | | | |
| LOCTITE ® LIOFOL | 50 | 50 | 50 | 50 |
| LA 6011 | | | | |
| Testing result | | | | |
| Viscosity (cps) | 831 | 1537 | 3165 | 15021 |
| Optical appearance | C | C | A | N/A |
| rate | | | | |

Remark: N/A refers to the composition is not able to attach on the testing layer due to high viscosity.

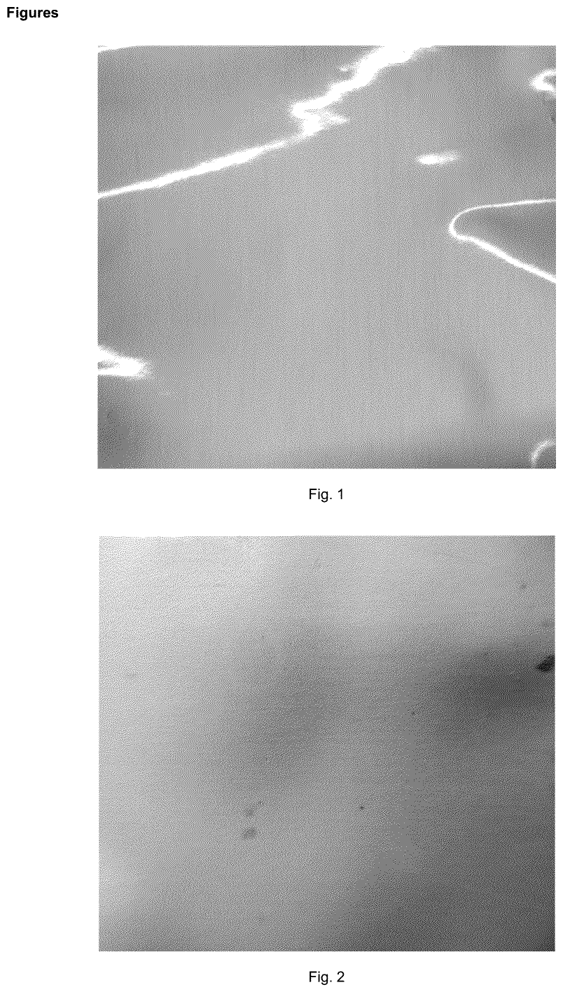

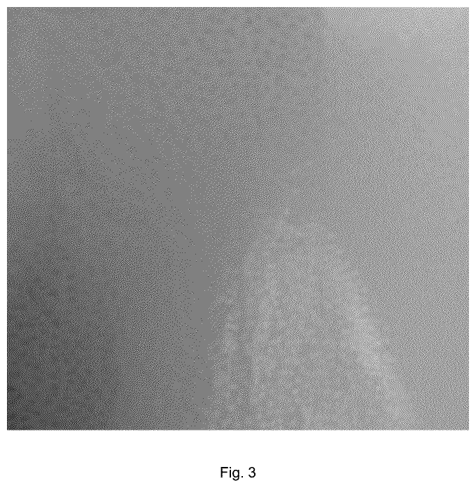

As can be seen from Table 1 and the FIGS. 1 and 2, compositions of Com. Ex.1 to Com. Ex.3 having NCO content out of the claimed range of the present invention had either unsatisfactory optical appearance or too high of viscosity to lack of workability, while the composition of the present invention (Ex.1) showed outstanding performance.

### Inventive Example 1 to 3 and Comparative Examples 4

In this set of examples, the solvent-free polyurethane adhesive compositions of the present invention (Ex.1 to 3) and composition having a component (A) out of the claims of the present invention (Coin. Ex.4) were prepared based on parts by weight specified in the Table 2.

TABLE 2

| Components | Com. | | | |
|---|---|---|---|---|
| (weight/g) | Ex. 4 | Ex.1 | Ex. 2 | Ex. 3 |
| Component (A) | | | | |
| DP 450 | 10.4 | 10.5 | 10.4 | 9.5 |
| DP 2000M | 26.0 | 26.3 | 26.0 | 23.9 |
| Castor oil | 0 | 0 | 0 | 1.9 |
| XCP-355 | 15.6 | 0 | 0 | 0 |
| PES 9000 | 0 | 0 | 15.6 | 0 |
| PES 5622 | 0 | 15.8 | 0 | 14.3 |
| Desmodur 44M | 48.1 | 47.3 | 48.0 | 50.4 |
| NCO % in | 11.5% | 11.5% | 11.5% | 11.5% |
| component (A) | | | | |
| Component (B) | | | | |
| LOCTITE ® | 50 | 50 | 50 | 50 |
| LIOFOL LA 6011 | | | | |
| Testing result | | | | |
| Viscosity (cps) | 3250 | 3165 | 3123 | 3250 |
| Optical | C | A | A | B |
| appearance rate | | | | |

As can be seen from Table 2, the composition having component (A) out of the claims of the present invention (Coin. Ex.4) had unsatisfactory optical appearance, while compositions of the present invention (Ex.1 to Ex.3) showed good performance.

These and other modifications and variations of the present invention may be practiced by those of ordinary skill in the art, without departing from the spirit and scope of the present invention. In addition, it should be understood that aspects of the various embodiments may be interchanged in whole or in reactant. Furthermore, those of ordinary skill in the art will appreciate that the foregoing description is by way of example only, and is not intended to limit the invention so further described in such appended claims.

1. A solvent-free polyurethane adhesive composition comprising:
(A) at least one isocyanate group-containing component comprising at least one isocyanate-terminated polyurethane prepolymer obtained by reacting a polyol mixture comprising:
(a) at least one polyester polyol obtained by reacting a reactant mixture comprising:
(i) at least one polycarboxylic acids selected from at least one aliphatic dicarboxylic acid and at least one aromatic dicarboxylic acid,
(ii) neopentyl glycol, and
(iii) at least one polyol having a weight average molecular weight of from 50 to 300 g/mol other than neopentyl glycol, and
(b) at least one polyether polyol having a weight average molecular weight of from 200 to 4000 g/mol,
with a stoichiometric excess of at least one polyisocyanate wherein the polyisocyanate present is 40-85% based on component (A), and
(B) at least one hydroxyl group-containing component;
wherein the isocyanate-containing component (A) has an NCO content of from more than 10% to less than 14% by weight.

2. The solvent-free polyurethane adhesive composition according to claim 1, wherein the polyester polyol (a) is modified by vegetable oil selected from castor oil, soybean oil, palm oil, coconut oil, or combinations thereof.

3. The solvent-free polyurethane adhesive composition according to claim 1, wherein the aliphatic dicarboxylic acid is C2-C36 aliphatic dicarboxylic acid selected from malonic acid, succinic acid, glutaric acid, adipic acid, pimelic acid, suberic acid, azelaic acid, sebacic acid, 1,12-dodecanedioic acid, dimer acid, and their corresponding polycarboxylic anhydrides, or combinations thereof.

4. The solvent-free polyurethane adhesive composition according to claim 1, wherein the aromatic dicarboxylic acid is C8-20 aromatic dicarboxylic acid selected from isophthalic acid, terephthalic acid, diphenic acid and 2,6-naphthalenedicarboxylic acid, and their corresponding polycarboxylic anhydrides.

5. The solvent-free polyurethane adhesive composition according to claim 1, wherein the component (iii) at least one polyol having a weight average molecular weight of from 50 to 300 g/mol other than neopentyl glycol is selected from ethylene glycol, diethylene glycol, 1,2-butanediol, 1,4-butanediol, 1,6-hexanediol, 2-methyl-1,3-propanediol, glycerol, trimethylolpropane, 1,2-propyleneglycol, dipropylene glycol, triethylene glycol, 1,4-cyclohexanedimethanol, 2-butyl-2-ethylpropanediol, pentaerythritol, polytetramethylene ether glycol or combinations thereof.

6. The solvent-free polyurethane adhesive composition according to claim 1, wherein the component (B) at least one polyether polyol having a weight average molecular weight of from 200 to 4000 g/mol is selected from polytetramethylene ether glycol, poly(oxypropylene) glycol, polyethylene oxide, polybutylene oxide, ethylene oxide endcapped versions of any of the foregoing.

7. The solvent-free polyurethane adhesive composition according to claim 6, wherein the component (b) has a weight average molecular weight (Mw) of from 450 to 2,000 g/mol.

8. The solvent-free polyurethane adhesive composition according to claim 6, wherein the polyisocyanate is selected from 4,4′-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, dimer fatty acid diisocyanate, lysine ester diisocyanate, 4,4-dicyclohexylmethane diisocyanate, 1,3-cyclohexane or 1,4-cyclohexane diisocyanate, or combinations thereof.

9. The solvent-free polyurethane adhesive composition according to claim 6, wherein the component (B) has a hydroxyl value in the range of from 56 to 560 mgKOH/g.

10. The solvent-free polyurethane adhesive composition according to claim 6, wherein the component (B) is selected from polyester polyols, polyether polyols, polyester ether polyols, polycarbonate polyols, or combinations thereof.

11. The solvent-free polyurethane adhesive composition according to claim 6, wherein the component (B) has an average hydroxyl group functionally of from 2 to 4.

12. The solvent-free polyurethane adhesive composition according to claim 6, wherein the mixing ratio of the component (A) and the component (B) is from 50:100 to 200:100 parts by weight.

13. A laminate, comprising a first layer, a second layer, and an adhesive layer sandwiched there between, wherein the first and second layer are independently of each other selected from films made of PET (Polyethylene Glycol Terephthalate), PP (Polypropylene), OPP (Oriented Polypropylene), CPP (Casted Polypropylene), BOPP (Biaxially oriented Polypropylene), PE (Polyethylene), aluminum foil, PA (Polyamide), VMPET (Vacuum Metallized Polyethylene Glycol Terephthalate) and VMCPP (Vacuum Metallized Casted Polypropylene), preferably PET (Polyethylene Glycol Terephthalate) and aluminum foil, and the adhesive layer being formed by curing the adhesive composition according to claim 1.

14. A package formed by the laminate of claim 13.

15. The package of claim 14 which is a food pouch.

16. The solvent-free polyurethane adhesive composition wherein the polyisocyanate present is 55-80% based on component (A) of claim 1.
